(19) United States
(12) Patent Application Publication
(10) Pub. No.: US 2005/0070825 A1
(43) Pub. Date: Mar. 31, 2005

(54) Disposable weight-reducing suction cup

(76) Inventor: Hidenori Hagiwara, Yokohama-shi (JP)

Correspondence Address: MUSERLIAN, LUCAS AND MERCANTI, LLP, 475 PARK AVENUE SOUTH, 15TH FLOOR, NEW YORK, NY, 10016, US

(21) Appl. No.: 10/498,290

(22) PCT Filed: Dec. 5, 2002
(86) PCT No.: PCT/JP02/12792

(30) Foreign Application Priority Data
Dec. 6, 2001 (JP) 2001-372327
Dec. 6, 2001 (JP) 2001-372328

(51) Int. Cl. A61H 7/00

(52) U.S. Cl. 601/6; 601/133

(57) ABSTRACT

The top (6) of a disposable weight-reducing suction cup (1) adapted to be intimately contacted with a weigh-reduction subject portion (8) is provided with a projection (24) and a thin-walled portion (35) disposed in the region of the inner surface of the cup (1) opposed to the projection (24). The cup (1) is intimately contacted with the weight-reduction subject portion (8), and then it is evacuated for suction by a pressure reducing valve (16) to dissipate the subcutaneous fat in the weight-reduction subject portion (8). After suction, this projection (24) is bent to destruct the thin-walled portion (35) to form a hole in the top (6), thereby equalizing the pressure in the cup with the outside pressure. This allows easy removal of the cup (1) from the weight-reduction subject portion (8). The absence of a complicated reduced pressure releasing mechanism results in an inexpensive disposable weight-reducing suction cup. Further, the barrel (4) of the weight-reducing suction cup (1) to be intimately contacted with the weight-reduction subject portion (8) is provided with a deformable portion (25) composed of a recess (20) and a thin-walled portion (18). The deformable portion (25) serves as a pressing portion adapted to be easily inwardly deformed and crushed when the interior (42) of the cup (1) is evacuated, and to laterally press the weight-reduction subject portion (8) to effectively dissipate subcutaneous fat.

### Technical Field

The present invention relates to a suction cup for slimming to reduce subcutaneous fat in a part of the body to be slimmed down, or to remove congestion in an affected part, and particularly relates to a disposable suction cup for slimming.

### BACKGROUND TECHNOLOGY

There is known a cupping treatment method for removing congestion, comprising the following steps. First, an opening of a suction cup called a sucker or a cupping glass is closely applied to an affected part. Then, the congestion inside the affected part is led to the surface by suctioning the affected area by depressurizing the interior of said cup. The depressurizing of the interior of the cup may be accomplished by a suction pump or the like, or by burning alcohol or the like in the cup. The congestion in the affected part is removed by the excretory process of blood vessels in the superficial part.

Further, a beauty regimen for slimming has been proposed utilizing the cupping treatment method. The opening of the cup is closely applied to a part of the body having a large amount of subcutaneous fat. The excess subcutaneous fat is dissipated and lost by suctioning the part of the body to be slimmed down.

However, the conventionally used cups are expensive. This is because a specialized check valve having a valve to relieve the depressurized state has to be installed, to remove the cups from a part of the body to be slimmed down after use.

In addition, a method with as much effect as possible is always desired for a beauty regimen for slimming, or for removing congestion in an affected part. A more effective method is also desired for such cases in which the cupping treatment is applied to a beauty regimen for slimming or to the treatment of an affected area.

In view of the situation described above, it is an object of the present invention to provide an inexpensive disposable suction cup for slimming, in which the depressurized state can be easily relieved after use.

In addition, another object of the present invention is to provide a disposable suction cup for slimming with which a better slimming effect can be expected.

### DISCLOSURE OF THE INVENTION

A suction cup for slimming of the present invention comprises: an opening end to be closely applied to a part of the body to be slimmed down; and is constructed so that a part of the body to be slimmed down is suctioned by the depressurization of the interior of the suction cup; wherein a portion of the surface of the suction cup is broken by a bending operation after suction, thereby relieving the depressurization of the interior thereof, and enabling removal of the suction cup from the part of the body to be slimmed down.

Said portion to be broken may comprise: a projection formed on the outer surface of a suction cup; and a thin-walled portion which is formed in the suction cup near the base of the projection, to be broken by bending the projection.

Moreover, the suction cup for slimming may include a deforming part which is deformed and flattened by depressurization, as well as a pressing part for pressing a part of the body to be slimmed down that is suctioned into the suction cup when the suction cup is deformed, provided at the inner surface thereof.

Furthermore, said deforming part may be constructed to be the pressing part, which is deformed inward when the pressure is reduced. The deformed part may press the part of the body to be slimmed down that is suctioned into the suction cup.

In addition, the pressing part can also be a projection that is formed on the inner surface of the suction cup.

According to the disposable suction cup for slimming of the present invention, a part to be broken is provided on the outer surface of the suction cup. This part to be broken is constructed so that the depressurization of the interior of the suction cup can be relieved by breaking the part to be broken by bending, after suctioning. Thereby, the suction cup can be removed from a part of the body to be slimmed down. Therefore a disposable suction cup for slimming is provided, which can be easily relieved of its depressurization, be directly disposed of and in addition, is inexpensive.

In a case in which said part to be broken comprises a projection formed on the outer surface of the suction cup and the thin-walled part of the cup which is to be broken by bending the projection, the operation to relieve depressurization can be performed extremely easily because the air pressures inside and outside the cup can be evened out simply by bending the projection. Moreover, the disposable suction cup for slimming can be inexpensive because it does not have a complicated system to relieve depressurization.

Further, in a case in which a suction cup for slimming has a deforming part which is to be deformed and flattened by depressurization as well as a pressing part inside it to press a part of the body to be slimmed down that is suctioned into it when it is deformed, excess subcutaneous fat in a part of the body to be slimmed down can be dissipated and effectively removed. In addition, there are effects to remove congestion inside the affected part and eliminate stiffness in the shoulder and the like, by pressing a part of the body to be slimmed down with the pressing part.

Further, in a case in which a deforming part is constructed to deform inward when the pressure is reduced and the inwardly deformed part is to be the pressing part which presses a part of the body to be slimmed down that is suctioned, the structure of the cup can be simplified because there is no need to make an additional pressing part.

Moreover, in a case in which the pressing part is a projection that is formed on the inner surface of the suction cup, excess subcutaneous fat in a part of the body to be slimmed down can be dissipated and lost, and congestion in an affected part can be removed more effectively, by pressing the projection against a part of the body to be slimmed down.

### BRIEF DESCRIPTION OF THE DRAWINGS

FIG. 1 is a longitudinal sectional view which shows the first embodiment of the disposable suction cup for slimming of the present invention.

FIG. 2A, FIG. 2B, and FIG. 2C show partial cross sections of the top of a disposable suction cup for slimming which shows a check valve; wherein FIG. 2A displays the check valve shown in FIG. 1, FIG. 2B displays the check valve of an alternate construction, and FIG. 2C displays the check valve of another alternate construction, respectively.

FIG. 3A and FIG. 3B show projections to relieve depressurization; wherein FIG. 3A is the partial cross section of the top with a projection shown in FIG. 1, and FIG. 3B is the partial cross section of the top that shows an alternate construction.

FIG. 4 is a front view of the disposable suction cup for slimming of the second embodiment.

FIG. 5 is a side view of the disposable suction cup for slimming of FIG. 4.

FIG. 6 is a bottom plan view of the disposable suction cup for slimming of FIG. 4.

FIG. 7 is a perspective view showing the disposable cup of FIG. 4 in use.

FIG. 8 is a bottom plan view of a disposable suction cup for slimming according to an alternate construction, which has grooves in three places.

FIG. 9 is a longitudinal sectional view which shows a third embodiment of the disposable suction cup for slimming of the present invention.

FIG. 10 is a cross sectional view showing the disposable suction cup for slimming of the third embodiment in use.

FIG. 11 is a cross sectional view which shows a disposable suction cup for slimming of the fourth embodiment of the present invention.

FIG. 12 is a cross sectional view which shows a disposable suction cup for slimming of the fifth embodiment of the present invention.

FIG. 13 is a cross sectional view which shows the disposable suction cup for slimming of FIG. 12 in use.

### BEST MODE FOR CARRYING OUT THE INVENTION

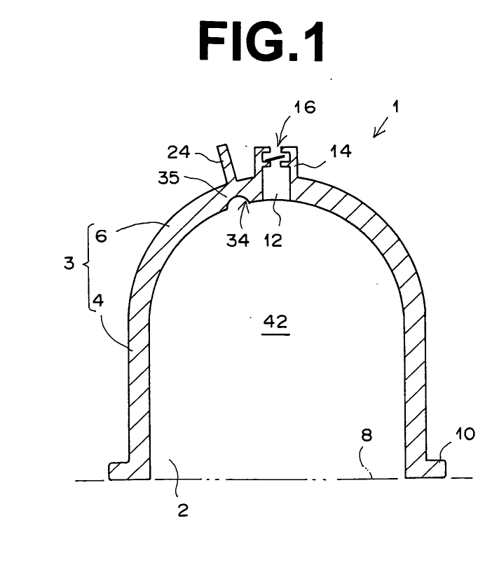

In the following, preferred embodiments of the invention are described in detail with reference to the drawings. FIG. 1 is a longitudinal sectional view which shows the first embodiment of the disposable suction cup for slimming (in the following simply referred to as “cup”) of the present invention. This cup 1 is made of resin, and has a bell-shaped, comparatively hard cup main body 3 with a round opening 2 at the bottom. The cup main body 3 has a cylindrical body 4 and a spherical top 6 which closes the upper part of the body 4. A flange 10, to be applied to a portion of the body to be slimmed down 8 to dissipate subcutaneous fat, is formed in the periphery of the opening 2 of the cup 1. A pipe 14, to connect an external hose (not shown in the figure) and the like for depressurization, is integrally formed on the top 6. A suction aperture 12, for depressurizing the interior of the cup 1 is formed through the pipe 14.

A check valve 16 is formed in this suction aperture 12 so that air does not flow back into the depressurized interior of the cup 1. The depressurized state inside the cup main body 3 is maintained by the check valve 16, even if connecting devices such as a hose is removed from the pipe 14 after the interior 42 of the cup main body 3 is depressurized with a suction pump (not shown in the figure). Therefore, it is possible to place one cup 1 on each of a plurality of parts of the body to be slimmed down 8, and to depressurize and set up these cups 1, connecting and releasing in turn hoses connected to a single suction pump. The detailed structure of the check valve 16 will be described later.

Moreover, near the pipe 14, a projection (the part to be broken) 24 protrudes from the top 6, formed integrally therewith. This projection 24 is provided to relieve depressurization by bending it and breaking the thin-walled part (the part to be broken) 35 of the top 6. The detailed structure of the projection 24 and the thin walled part 35 will be described later.

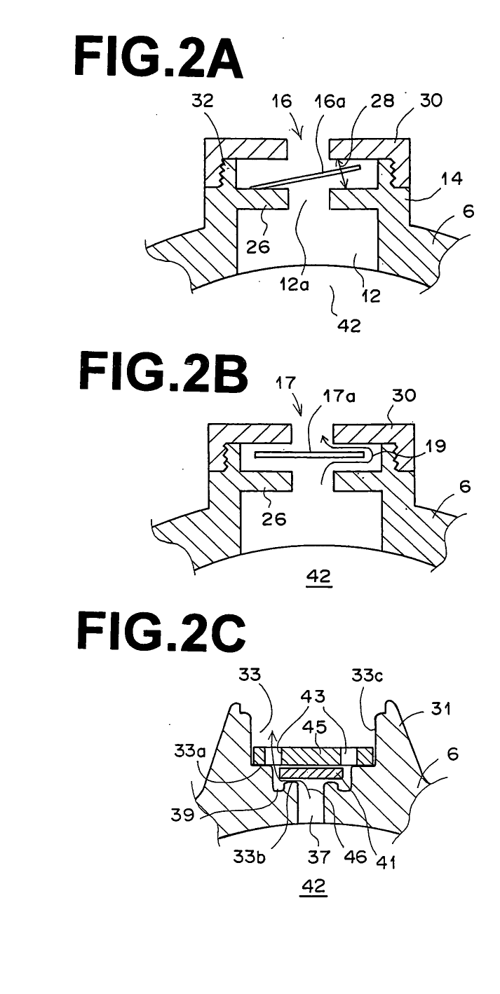

Next, the structure of the check valve 16 will be described in detail with reference to FIG. 2A, FIG. 2B, and FIG. 2C. FIG. 2A, FIG. 2B, and FIG. 2C show partial cross sections of the top 6 showing the check valve 16, wherein FIG. 2A displays the check valve 16 shown in FIG. 1, FIG. 2B displays the check valve of an alternate construction, and FIG. 2C displays the check valve of another alternate construction, respectively. As shown in FIG. 2A, a partition 26 with an eyelet 12a is formed inside the pipe 14. A discoid valve element 16a is mounted above this partition 26. One end of this valve element 16a is fixed to the partition 26, and it can move as shown by the arrow 28 between a closed position, in which it is flush against the partition 26, thereby shutting off the eyelet 12a when the pressure is reduced, and an open position, in which the interior air can pass through to the exterior as shown in FIG. 2A during suction. Threads 32 are formed at the tip of the pipe 14, and a rim 30 is screwed onto these threads 32 to protect the valve element 16a. A tube or a hose that is not shown in the figure is usually fixed to the periphery of the pipe 14, and it is constructed to be connected to a suction instrument to depressurize the air of the interior 42 of the cup 1. The detailed description of this construction is abbreviated because any known method can be applied to it.

Next, the check valve 17 of an alternate construction shown in FIG. 2B will be described. It is different from the embodiment shown in FIG. 2A in the point that the valve element 17a is discoid like in FIG. 2A but it is placed to move freely between the partition 26 and the rim 30. This valve element 17a floats when the air of the interior 42 is suctioned, and the airway is secured as shown in FIG. 2B by the arrow 19. When suctioning is stopped and the hose is pulled out, the valve element 17a becomes flush against the partition 26 because the interior 42 is depressurized, and maintains the depressurized state of the interior 42.

Next, another alternate construction shown in FIG. 2C will be described. In this embodiment, a conical projection 31 with an outwardly facing concave part 33 is formed integrally with the top 6. The interior of the concave part 33 has annular tiers 33a and 33b, and communicates with an aperture 37. An annular groove 39 is formed in the periphery of the tier 33b. A discoid valve element 41 made of a comparatively flexible sponge resin is placed on the tier 33b. A discoid lid 45 having an aperture 43 is press fit into an inner wall surface 33c of the concave part 33, and fixed on the tier 33a. During suction, the valve element 41 moves slightly upward to secure an airway as shown by the arrow 46. After the interior 42 is depressurized, as the hose that is not shown in the figure is pulled out, the valve element 41 is pressed against the tier 33b, and the depressurized state of the interior 42 is maintained.

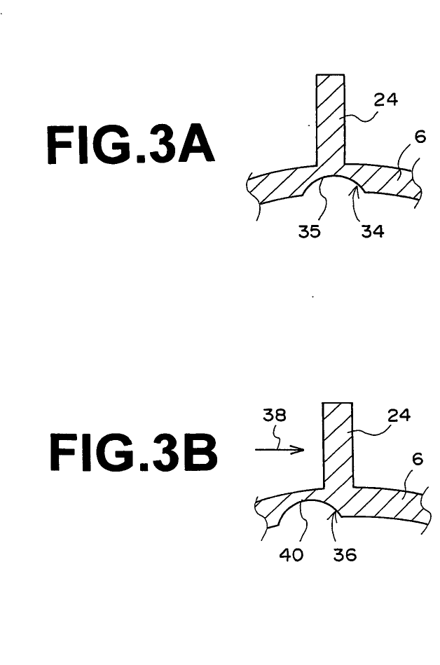

Next, the projection 24 for relieving depressurization will be described with reference to FIG. 3A and FIG. 3B. FIG. 3A is a partial cross section of the top 6 with the projection 24 shown in FIG. 1. FIG. 3B is the partial cross section of the top 6 that shows an alternate construction. As shown in FIG. 3A, in the top 6 in which the projection 24 is formed, a round concave part 34 is formed on the rear surface corresponding to the base of the projection 24. The thickness of the top 6 at the bottom is thinner because of that the concave part 34. For that reason, when the projection 24 is pushed down to the lateral direction, the thin-walled part 35 is broken, to make an aperture in the top 6, and the air pressures of the interior and the outside of the cup 1 are evened out. In other words, when the pressure of the interior is reduced, the depressurization is relieved and the cup 1 can be easily removed from the part of the body to be slimmed down 8. In addition, FIG. 3B shows the concave part 36 displaced from the projection 24. In this case, the thin-walled part 40 will be broken when the projection 24 is pressed in the direction of the arrow 38. The concave parts 34 and 36 in said embodiments are circular concave parts; however, the concave parts may be of any other form, including squares and rectangles.

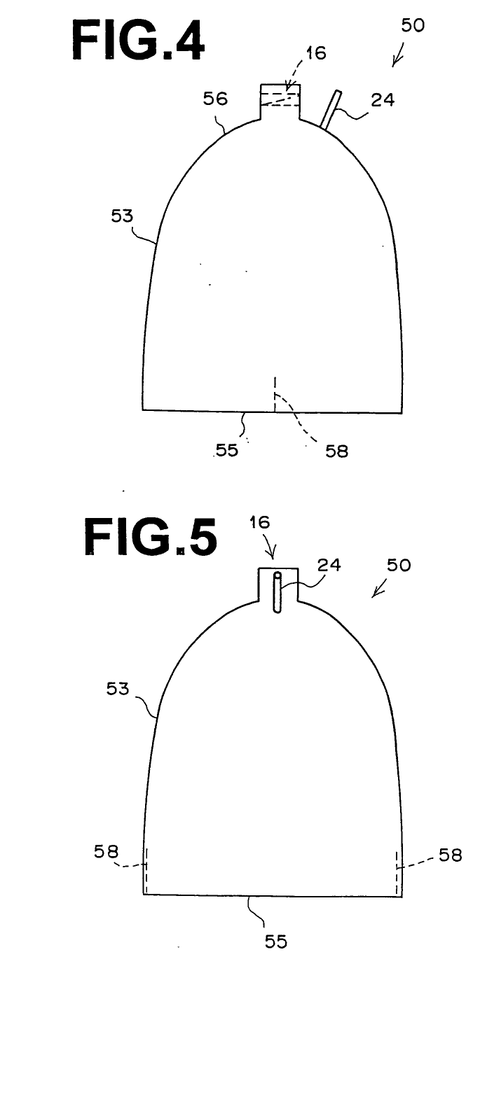

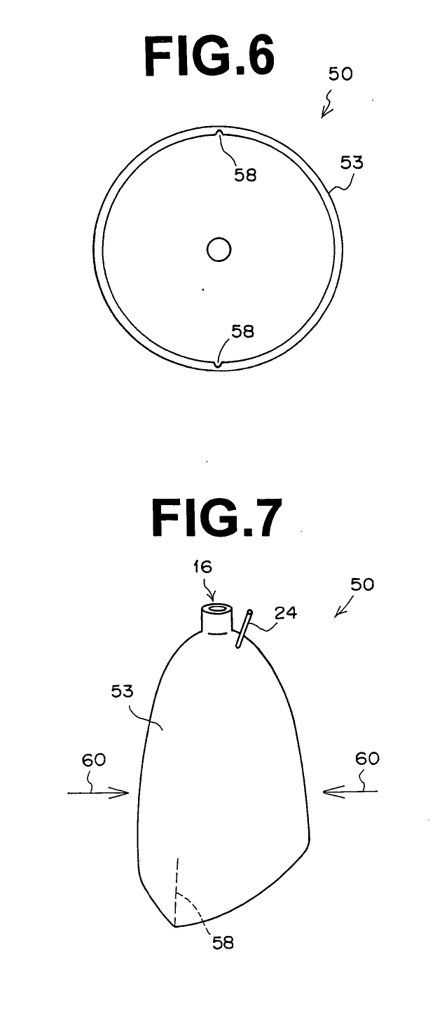

Next, the cup of the second embodiment will be described with reference to FIG. 4 through FIG. 6. FIG. 4 is a front view of a cup 50 of the second embodiment. FIG. 5 is a side view of the cup 50 of FIG. 4; and FIG. 6 shows the bottom plan view of the cup 50 of FIG. 4, respectively. Note that the same parts as those shown in FIG. 1 are denoted with the same reference numbers in the description. The cup 50 has a bell-shaped main body 53, in the same manner as the cup 1 of the first embodiment described above. An opening end 55 at the bottom, a check valve 16 on the top 56, and a protruded part or a projection 24 are also formed similarly to the first embodiment described above. The points that are different from the first embodiment shown in FIG. 1 are that the main body 53 is formed with a thinner material as a whole than the main body 3 shown in FIG. 1, and that short grooves 58 are formed in the interior surface of the main body 53 at the front and back thereof, extending from the opening end 55 upward. When viewed from the bottom, the grooves 58 are located to be opposed across the center of the cup 50, as shown in FIG. 6.

FIG. 7 shows the cup 50 constructed in this manner in use. FIG. 7 is the perspective illustration which shows the cup 50 of FIG. 4 in use. During suction, the left and the right parts of the grooves 58 dent by receiving force by the air pressure as shown by arrows 60. The part of the body to be slimmed down 8 that is suctioned is pressed from both sides because of the denting of the main body 53, and subcutaneous fat can be effectively dissipated. In this embodiment also, the cup 50 can be easily removed by relieving depressurization by bending the projection 24.

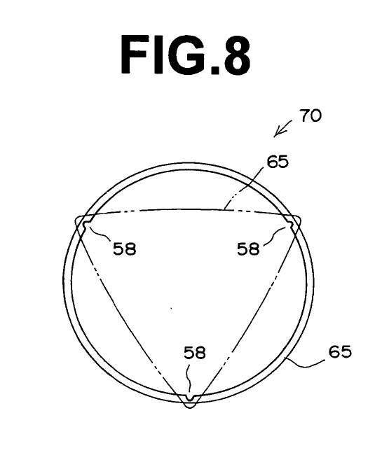

Moreover, the number of the grooves 58 can be increased as shown in FIG. 8. FIG. 8 shows a bottom plan view of a cup 70 of an alternate construction, in which the grooves 58 are formed in three places. When pressure is reduced, the opening end 65 is flattened inward roughly in the shape of a triangle as shown by broken lines, because the grooves 58 are provided in three places. Because of this flattening, the part of the body to be slimmed down 8 is pressed from three directions, and the slimming effect is further enhanced. Various modifications and changes are possible regarding the number of the grooves 58, or the circumferential locations at which the grooves 58 are formed.

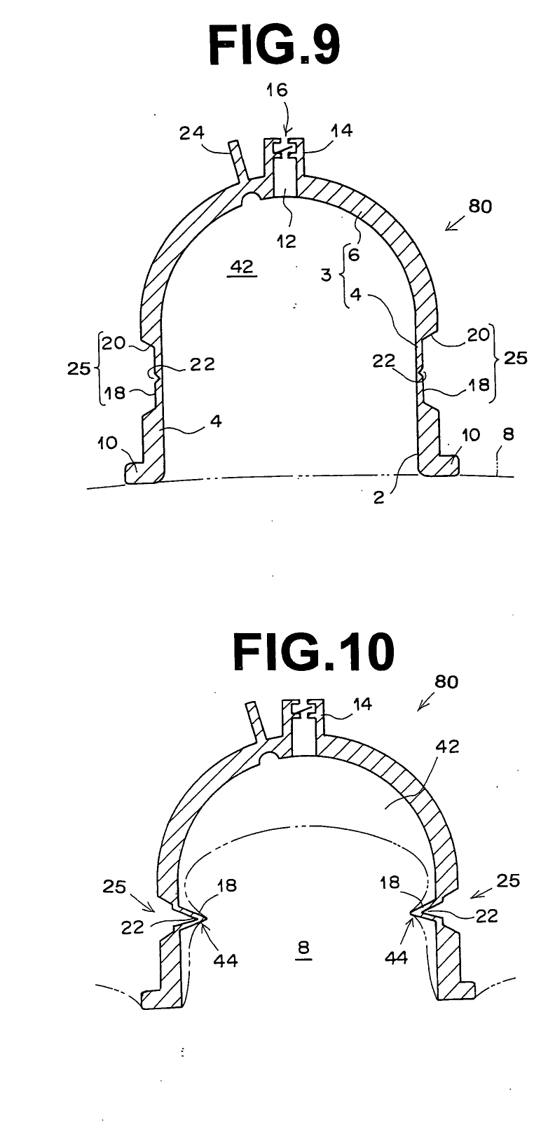

Next, a cup of the third embodiment, which is the cup 1 shown in FIG. 1 in which a deforming part is formed, will be described with reference to FIG. 9. FIG. 9 is a cross sectional view of a cup 80 with a deforming part 25. Note that the same parts as those of the cup 1 shown in FIG. 1 are denoted with the same reference numbers in the description. As shown in FIG. 9, deforming parts 25 that are deformed at the time of depressurization are formed in a plurality of circumferential locations in the body 4. Each deforming part 25 comprises a concave part 20 and a thin-walled part 18 formed by this concave part 20. The cup 80 flattens at the thin-walled parts 18 when pressure is reduced. The thin-walled parts 18 are made thin by forming said concave parts 20 in the exterior surface of the body 4, toward the interior thereof. A groove 22, which makes the thin-walled parts 18 thinner to facilitate deformation thereof, is formed in the circumferential direction of the body 4. The groove 22 also serves to define the position at which the thin walled portions 18 protrude during deformation thereof.

Next, the manner in which the cup 80 of the third embodiment shown in FIG. 9 is applied to the part of the body to be slimmed down 8 and suctioned will be described with reference to FIG. 10. FIG. 10 is a cross sectional view which shows the cup 80 of FIG. 9 in use. Note that a tube or a hose to be connected to the pipe 14 when it is suctioned and the method (instrument) for suctioning are omitted in FIG. 10. As the interior 42 of the cup 80 is depressurized, the thin-walled parts 18 of the deforming parts 25 fold at the part of the groove 22 to be deformed inward, and become pressing parts 44 which protrude into the interior 42. The part of the body to be slimmed down 8 that is being suctioned into the cup 80 due to the depressurization is pressed from the lateral direction by said pressing parts 44. Because of this pressing, excess subcutaneous fat in the part of the body to be slimmed down 8 can be effectively dissipated and lost.

Next, the fourth embodiment of the present invention will be described with reference to FIG. 11. FIG. 11 is a cross sectional view similar to FIG. 1 of a cup 100 with concave parts 120 different from the embodiment shown in FIG. 9. The concave parts 120, or deforming parts, have substantially the same thickness as the body 104 of the cup 100. However, the concave parts 120 are dented into the cup 100, that is, toward the interior 142. The concave parts 120 are provided in a plurality of the locations along the circumference of the cup 100. The concave parts 120 are flattened by the depressurization of the interior 142, and then protrude inward to become pressing parts 144 indicated by the broken lines. The pressing parts 144 press the part of the body to be slimmed down 8 to exhibit a slimming effect similar to that exhibited by the first embodiment.

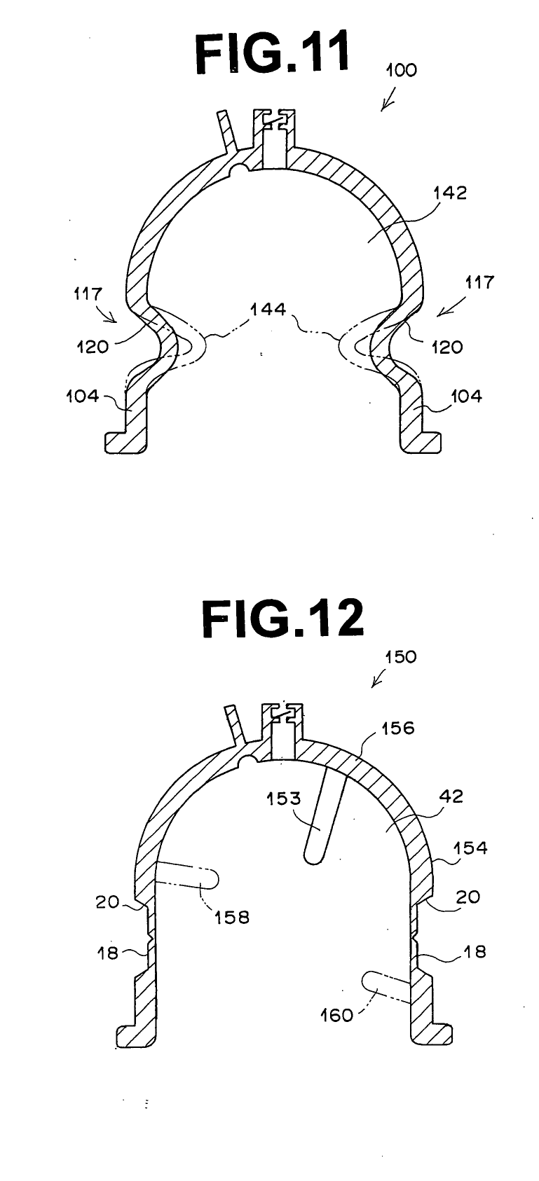

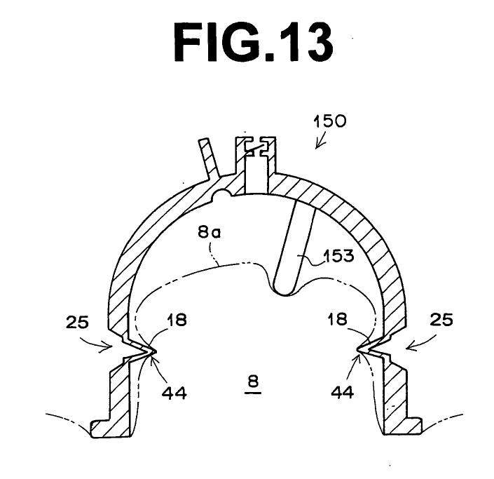

Next, the fifth embodiment will be described with reference to FIGS. 12 and 13. FIG. 12 displays a cross section of a cup 150 of the fifth embodiment, and FIG. 13 shows a cross section of the cup 150 in use, similar to FIG. 10, respectively. Note that the parts having the same construction as FIG. 9 are described using the same reference numbers. In this embodiment, in addition to the construction of the cup 80 shown in FIG. 9 described above, a protrusion (projection) 153 which is to be a pressing part to press the part of the body to be slimmed down 8 when it is suctioned is provided in the interior 42 of the cup. In this embodiment, the protrusion 153 is made at the top 156. The location of the protrusion 153 is not limited to the top 156. For example, a protrusion denoted by reference number 158 may be provided in the upper part of the body 154, or a protrusion denoted by reference number 160 may be provided in the lower part of the body 154, as indicated by the broken lines.

Next, the cup 150 of the fifth embodiment in use will be described with reference to FIG. 13. In this embodiment, when the cup 150 is depressurized, the lateral sides of the part of the body to be slimmed down 8 is pressed by the pressing parts 44 which are formed by the deformation of the deforming parts 25. In addition, an upper side 8a of the part of the body to be slimmed down 8 is pressed by the protrusion 153. By the doubly applied pressure, subcutaneous fat is pressed and a greater slimming effect and a greater effect to remove congestion in an affected part can be obtained.

The embodiments of the invention have been described in detail above. However, it is needless to say that the present invention is not limited to the embodiments described above and various changes an modifications are possible. For example, the shapes of the concave parts 20 and 120 can be made with a slope on the body 4 and the body 104, respectively, so that the cups 80 and 100 are twisted when the pressure is reduced to also give the part of the body to be slimmed down 8 a slimming effect by a twisting effect. Various cases of the size, shape and location of the concave parts 20 and 120 are possible according to the part of the body to be slimmed down 8 to be suctioned. In addition, various combinations of the concave parts 20 and 120, and the protrusions 153, 158, and 160 are possible.

1. A disposable suction cup for slimming, constructed so that a part of the body to be slimmed down is suctioned by depressurization of an interior of the suction cup, comprising:
an opening end to be closely applied to the part of the body to be slimmed down,
wherein a portion of the surface of the suction cup is broken by a bending operation after suction, thereby relieving the depressurization of the interior thereof, and enabling removal of the suction cup from the part of the body to be slimmed down.

2. A disposable suction cup for slimming as defined in claim 1, wherein said portion to be broken comprises:
a projection formed on the outer surface of a suction cup; and
a thin-walled portion which is formed in the suction cup near the base of the projection, to be broken by bending the projection.

3. A disposable suction cup for slimming as defined in claim 1, further comprising:
a deforming part which is deformed and flattened by depressurization; and
a pressing part for pressing the part of the body to be slimmed down which is suctioned into the suction cup when the suction cup is deformed, provided at the inner surface thereof.

4. A disposable suction cup for slimming as defined in claim 3,
wherein said deforming part is constructed to be the pressing part, which is deformed inward during depressurization to press the part of the body to be slimmed down which is suctioned into the suction cup.

5. A disposable suction cup for slimming as defined in claim 3,
wherein the pressing part comprises a projection that is formed on the inner surface of the suction cup.

6. A disposable suction cup for slimming as defined in claim 2, further comprising:
a deforming part which is deformed and flattened by depressurization; and
a pressing part for pressing the part of the body to be slimmed down which is suctioned into the suction cup when the suction cup is deformed, provided at the inner surface thereof.

7. A disposable suction cup for slimming as defined in claim 4,
wherein the pressing part comprises a projection that is formed on the inner surface of the suction cup.

8. A disposable suction cup for slimming as defined in claim 6,
wherein said deforming part is constructed to be the pressing part, which is deformed inward during depressurization to press the part of the body to be slimmed down which is suctioned into the suction cup.

9. A disposable suction cup for slimming as defined in claim 6,
wherein the pressing part comprises a projection that is formed on the inner surface of the suction cup.

10. A disposable suction cup for slimming as defined in claim 8,
wherein the pressing part comprises a projection that is formed on the inner surface of the suction cup.
